(19) United States
(12) Patent Application Publication
(10) Pub. No.: US 2022/0383228 A1
(43) Pub. Date: Dec. 1, 2022

(54) MULTILINGUAL SUBTITLE SERVICE SYSTEM AND METHOD FOR CONTROLLING SERVER THEREOF

(71) Applicant: GLOCALIZE INC., Seoul (KR)

(72) Inventors: Kug Koung LEE, Seoul (KR); Ho Kyun KIM, Seoul (KR); Bong Wan KIM, Seoul (KR)

(21) Appl. No.: 17/424,077

(22) PCT Filed: Jun. 12, 2021
(86) PCT No.: PCT/KR2021/007366

§ 371 Date: Jul. 19, 2021

(30) Foreign Application Priority Data
May 25, 2021 (KR) 10-2021-0066922

(51) Int. Cl. G06Q 10/06; H04N 21/488; H04N 21/485; G06F 40/51

(52) U.S. Cl. CPC G06Q 10/06398; H04N 21/4884; H04N 21/4856; G06F 40/51; G06Q 10/06395

(57) ABSTRACT

Proposed are a multilingual subtitle service system and a method for controlling a service server thereof. The subtitle service system includes: a subtitle service server configured to, in response to a request from a worker, provide a subtitle content creating tool for creating a subtitle content for a content image requested by a client and evaluate task performance of the worker based on the subtitle content created by the worker; and a user terminal device configured to access the subtitle service server to transmit project information on the content image requested by the client, and, in response to a request from the worker, display a subtitle service window including the subtitle content creating tool provided by the subtitle service server.

### BACKGROUND OF THE DISCLOSURE

### Field of the disclosure

The present disclosure relates to a service system for providing a multilingual subtitle service and a method of controlling a server thereof, and more particularly, to a service system capable of providing a multilingual subtitle service by having a multilingual subtitle content creating tool dedicated to online video content and capable of integrally requesting and performing a subtitle content task for various content images, and a method for controlling a server thereof.

### Related Art

With the development of the Internet, various content images can be produced and played back, and users from various countries are able to watch the content images easily and quickly. Accordingly, creators of the content images translate source languages included in the content images into various languages so that users in different countries can watch the content images more conveniently.

However, there is a limit to the creators themselves in translating into various languages, and when translation is requested to a translator, information on the translator is insufficient, and thus, it may be translated with a word or expression possibly understood as a different meaning from the content image or it may take a lot of time to find a translator who can translate into a language requested by a client.

Therefore, various methods for easier and faster translation of content images should be sought.

### SUMMARY

The present disclosure provides a subtitle service capable of integrally requesting and performing a subtitle content task for a content image.

In an aspect, there is provided a subtitle service system, the subtitle service system includes: a subtitle service server configured to, in response to a request from a worker, provide a subtitle content creating tool for creating a subtitle content for a content image requested by a client and evaluate task performance of the worker based on the subtitle content created by the worker; and a user terminal device configured to access the subtitle service server to transmit project information on the content image requested by the client, and, in response to a request from the worker, display a subtitle service window including the subtitle content creating tool provided by the subtitle service server. The project information includes at least one of address information, title information, description information, and subtitling request information for the content image.

The subtitle service providing server may include: a communication unit configured to perform data communication with at least one of: a user terminal device of the client, and a user terminal device of the worker; a storage unit configured to store the project information on the content image received from the user terminal device of the client; and a controller configured to control the communication unit and the storage unit. The controller may include a project creating unit configured to: when a subtitle request command including the project information on the content image is received from the user terminal device of the client, determine as to validity of the content image based on the address information included in the project information, and when the validity of the content image is verified, store the project information in the storage unit; and when the validity of the content image is not verified, transmit an error message to the user terminal device of the client through the communication unit.

The storage unit may be further configured to store at least one of profile information of pre-registered workers. The controller may further include a worker search unit configured to: when a worker search command is received from the user terminal device of the client, acquire profile information related to subtitling request information included in project information among pre-registered profile information and transmit the acquired profile information to the user terminal device of the client; and when translation request information is received from the user terminal device of the client that has received the profile information, transmit a translation request message to a user terminal device of a worker corresponding to the profile information.

The controller may further include a task executing unit configured to: when a project search command is received from the user terminal device of the worker, transmit, to the user terminal device of the worker, project list information including an item corresponding to at least one content image created based on the project information stored in the storage unit; and when a command to select a first item is received from the user terminal device of the worker, transmit, based on project information of a first content image corresponding to the selected first item, Web information on a subtitle content creating tool for creating a subtitle content of the first content image to the user terminal device of the worker.

The task executing unit may be configured to: when a task-completed subtitle content is received from the user terminal device of the worker, store the received subtitle content in the storage unit; and transmit a project completion message to the user terminal device of the client who has requested the subtitle content.

The storage unit may include: a temporary storage unit configured to store the task-completed subtitle content; and a final storage unit configured to store a verified subtitle content among subtitle contents stored in the temporary storage unit. The task executing unit may be further configured to: when a review command is received from a user terminal device of a reviewer, provide a list of subtitle contents stored in the temporary storage unit, and when a command to select a first subtitle content from among the subtitle contents included in the list is received, transmit Web information on a review tool for the first subtitle content to the user terminal device of the reviewer; and when a review completion message for the first subtitle content is received from the user terminal device of the reviewer, delete the first subtitle content stored in the temporary storage unit and store the first subtitle content reviewed by the reviewer in the final storage unit.

The controller may further include a member management unit configured to, when a registration request command is received from a user terminal device of an unregistered worker, generate task rating information on the unregistered worker by evaluating text performance of the unregistered worker, generate profile information, which includes the task rating information and at least one of personal information, history information, cost information, and evaluation information provided from the unregistered worker, and store the generated profile information in the storage unit.

The member management unit may be further configured to update task rating information on a pre-registered worker using at least one of: task execution period information for a subtitle content task-completed by the pre-registered worker, error correction information, and evaluation information by a user who has used the subtitle content.

The user terminal device may include: a communication unit configured to perform data communication with the subtitle service server; an input unit configured to receive a user command; a display; and a controller configured to: display the subtitle service window in accordance with a user command input through the input unit, and when a command to select a project creating icon included in an area of the subtitle service window is received, control the display to display a first client window for inputting project information on the content image. The first client window may include at least one of: a first UI for setting at least one of a language task and a translation task of the content image, and a second UI for inputting address information on the content image.

The subtitle service window may further include a My Project icon for searching for a progress status of a project requested by the client. The controller may be further configured to, when a command to select the My Project icon is received, control the display to display a second client window for the project search by the client. The second client window may include at least one of: a first UI for setting a progress status of the project requested by the client, a second UI for searching for a project task execution period, a third UI for selecting a source language of the content image, a fourth UI for selecting a target language, and a fifth UI for searching for a specific project.

The subtitle service window may further include at least one of: a project search icon for searching for a project to work on, and a worker project search icon for searching for a project assigned to the worker. The controller may be further configured to, when a command to select the project search icon is received, control the display to display a first worker window for searching for a project available to work on. The first worker window may include at least one of: a first UI for selecting a source language included in the content image, a second UI for selecting a target language requested by the client, a third UI for selecting a task execution period, a fourth UI for selecting a category for the content image, and a fifth UI for setting task difficulty.

The controller may be further configured to, when a command to select the worker project search icon is received, control the display to display a second worker window for searching for a project assigned to the worker. The second worker window may include at least one of: a first UI for selecting a task type, a second UI for searching for a task progress status, a third UI for selecting a remaining task execution period, a fourth UI for selecting a source language included in the content image, and a fifth UI for selecting a target language.

The controller may be further configured to, when one of projects found through the second worker window is selected, control the display to display a subtitle content creating tool window for performing a task on the selected project. The display may be further configured to display a content image related to the selected project in a first area of the subtitle content tool window, display a subtitle content creating tool UI for creating a subtitle content for each section of the content image in a second area of the subtitle content tool window, and display a subtitle content editing tool UI for editing a playback period of a subtitle content for each section created through the subtitle content creating tool UI in a third area of the subtitle content tool window.

The subtitle service window may further include a performance evaluation icon for searching for a task performance indicator of a worker. The controller may be further configured to, when a command to select the performance evaluation icon is received, control the display so as to display a worker performance evaluation window including at least one of: a first UI for a performance evaluation test of an unregistered worker, and a second UI for providing test performance evaluation information on a pre-registered worker.

In another aspect, there is provided a method for controlling a subtitle service server that provides a subtitle service, and the method includes: registering project information on a content image requested by a client; transmitting, in response to a request from a worker, a subtitle content creating tool for creating a subtitle content for the content image requested by the client to a user terminal device of the worker; transmitting the project information on the content image to the user terminal device of the worker; receiving, from the user terminal device of the worker, a task-completed subtitle content for the content image through a subtitle service window including the subtitle content creating tool; evaluating task performance of the worker based on the received subtitle content; and storing the received subtitle content based on the evaluation information. The project information may include at least one of: address information, title information, description information, and subtitling request information for the content image.

The registering may include: receiving a subtitle request command including project information for a content image from a user terminal device of the client; determining as to validity of the content image based on the address information included in the project information; and when the validity of the content image is verified, storing the project information in the storage unit, and when the validity of the content image is not verified, transmitting an error message to the user terminal device of the client.

The method may further include: when a worker search command is received from the user terminal device of the client, acquiring profile information related to the subtitling request information included in the project information among pre-registered workers' profile information and transmitting the acquired information to the user terminal device of the client; and when translation request information is received from the user terminal device of the client who has received the profile information, transmitting a translation request message to a user terminal device of an worker corresponding to the profile information.

The method may further include: when a project search command is received from the user terminal device of the worker, transmitting project list information including an item corresponding to at least one content image generated based on pre-stored project information to the user terminal device of the worker; and when a command to select a first item is received from the user terminal device of the worker, transmitting, based on project information on a first content corresponding to the selected first item, Web information on a subtitle content creating tool for creating a subtitle content of the first content to the user terminal device of the worker.

The method may further include: transmitting a project completion message to the user terminal device of the client who has requested the subtitle content. The storing may include: when a task-completed subtitle content is received from the user terminal device of the worker, storing the received subtitle content in a temporary storage unit; when an review command is received from a user terminal device of a reviewer, providing a list of subtitle contents stored in the temporary storage unit; when a command to select a first subtitle content from among the subtitle contents included in the list is received, transmitting Web information on an review tool for the first subtitle content to the user terminal device of the reviewer; and when a review completion message regarding the first subtitle content is received from the user terminal device of the reviewer, deleting the first subtitle content stored in the temporary storage unit and storing the first subtitle content reviewed by the reviewer in the final storage unit.

The method may further include: when a registration request command is received from a user terminal device of an unregistered worker, generating task rating information on the unregistered worker by evaluating text performance of the unregistered worker; generating and storing profile information, which includes the task rating information and at least one of personal information, history information, cost information, and evaluation information provided from the unregistered worker; and updating task rating information on a pre-registered worker using at least one of the following: task execution period information for a subtitle content task-completed by a pre-registered worker, error correction information, and evaluation information by a user who has used the subtitle content.

As described above, according to various embodiments of the present disclosure, the subtitle service system can provide a subtitle service that can integrally request and perform a subtitle content task for a content image.

In addition, for a video content distributed online in various resource forms, the present disclosure provides subtitle service-dedicated tools, which can be effectively used by a client who requests a subtitle content task including a source-language and target-language task, a worker who performs the source-language and target-language task, and a reviewer who verifies the quality of a created subtitle content, thereby improving productivity of the subtitle content.

In addition, the present disclosure provides a subtitle service system that intermediaries a subtitle content worker, a subtitle content client, and a subtitle content reviewer, thereby providing a new revenue model to the worker and the reviewer and reducing the cost required for creating a subtitle content to the client.

### BRIEF DESCRIPTION OF THE DRAWINGS

FIG. 1 is a diagram illustrating a subtitle service system according to an embodiment of the present disclosure.

FIG. 2 is a block diagram of a subtitle service server according to an embodiment of the present disclosure.

FIG. 3 is a detailed block diagram of a storage unit according to an embodiment of the present disclosure.

FIG. 4 is a block diagram of a user terminal device according to an embodiment of the present disclosure.

FIGS. 5 and 6 are diagrams illustrating an example of displaying a subtitle service window for a client in a user terminal device according to an embodiment of the present disclosure.

FIGS. 7 to 9 are views illustrating an example of displaying a subtitle service window for an worker in a user terminal device according to an embodiment of the present disclosure.

FIG. 10 is a flowchart of a method for controlling a subtitle service server according to an embodiment of the present disclosure.

### DESCRIPTION OF EXEMPLARY EMBODIMENTS

Hereinafter, various embodiments of this document will be described with reference to the accompanying drawings. However, it should be understood that technology described in this document is not limited to a specific embodiment and includes various modifications, equivalents, and/or alternatives of an embodiment of this document. The same reference numbers are used throughout the drawings to refer to the same or like parts.

In this document, an expression such as “have,” “may have,” “comprise,” or “may comprise” indicates existence of a corresponding characteristic (e.g., constituent element such as a numerical value, function, operation, or component) and does not exclude the presence of another characteristic.

In this document, an expression such as “A or B”, “at least one of A or/and B”, or “one or more of A or/and B” may include all possible combinations of together listed items. For example, “A or B,” “at least one of A and B,” or “one or more of A or B” may indicate all of (1) a case of including at least one A, (2) a case of including at least one B, and (3) a case of including both at least one A and at least one B.

An expression such as “first” and “second” used in this document may indicate various constituent elements regardless of order and/or importance, is used for distinguishing a constituent element from another constituent element, and does not limit corresponding constituent elements.

When it is described that a constituent element (e.g., a first constituent element) is “(operatively or communicatively) coupled with/to” or is “connected to” another constituent element (e.g., a second constituent element), it should be understood that the constituent element may be directly connected to the another constituent element or may be connected to the another constituent element through another constituent element (e.g., a third constituent element). However, when it is described that a constituent element (e.g., a first constituent element) is “directly connected” or is “directly accessed” to another constituent element (e.g., a second constituent element), it may be understood that another constituent element (e.g., a third constituent element) does not exist between the constituent element and the other constituent element.

An expression “configured to” used in this document may be interchangeably used with, for example, “suitable for”, “having the capacity to”, “designed to”, “adapted to”, “made to”, or “capable of” according to a situation. A term “configured to” does not always mean “specifically designed to” in hardware. Alternatively, in any situation, an expression “device configured to” may mean that the device is “capable of” being configured together with another device or component. For example, a “processor configured to perform phrases A, B, and C” may be a generic-purpose processor (e.g., CPU or application processor) that executes an exclusive processor (e.g., an embedded processor) for performing a corresponding operation or at least one software program stored at a memory device to perform a corresponding operation.

An electronic device according to various embodiments of this document may include at least one of, for example, a smart phone, tablet personal computer (tablet PC), mobile phone, video phone, e-book reader, desktop PC, laptop PC, netbook computer, workstation, server, personal digital assistant (PDA), portable multimedia player (PMP), moving picture experts group layer-3 (MP3) player, mobile medical device, camera, and wearable device. According to various embodiments, the wearable device may include at least one of an accessory type device (e.g., watch, ring, bracelet, ankle bracelet, necklace, glasses, contact lens), head-mounted-device (HMD), textile or clothing integral type device (e.g., electronic clothing), body attachment type device (e.g., skin pad or tattoo), and bio implanted type device (e.g., implantable circuit). In an embodiment, the electronic device may include at least one of, for example, a television, digital video disk (DVD) player, audio device, refrigerator, air-conditioner, cleaner, oven, microwave oven, washing machine, air cleaner, set-top box, home automation control panel, security control panel, television box (e.g., Samsung HomeSync™, AppleTV™, or Google TV™), game console (e.g., Xbox™, PlayStation™), electronic dictionary, electronic key, camcorder, and electronic frame.

In another embodiment, an electronic device may include at least one of various medical devices (e.g., various portable medical measurement devices (blood sugar measurement device, heartbeat measurement device, blood pressure measurement device, or body temperature measurement device), magnetic resonance angiography (MRA) device, magnetic resonance imaging (MRI) device, computed tomography (CT) device, scanning machine, and ultrasonic wave device), navigation device, global navigation satellite system (GNSS), event data recorder (EDR), flight data recorder (FDR), vehicle infotainment device, ship electronic equipment (e.g., ship navigation device, gyro compass), avionics, security device, vehicle head unit, industrial or home robot, automatic teller's machine (ATM) of a financial institution, point of sales (POS) of a store, and Internet of things (e.g., bulb, various sensors, electricity or gas meter, sprinkler, fire alarm, thermostat, street light, toaster, exercise mechanism, hot water tank, heater, boiler).

In this document, a term “user” may indicate a person using an electronic device or a device (e.g., artificial intelligence electronic device) using an electronic device.

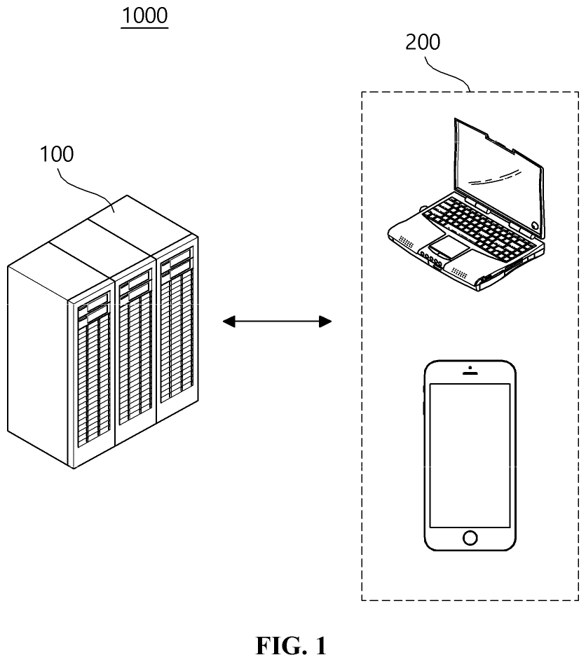

FIG. 1 is a diagram illustrating an example of a subtitle service system according to an embodiment of the present disclosure.

As shown in FIG. 1, a subtitle service system 1000 includes a subtitle service server 100 and at least one user terminal device 200.

The subtitle service server 100 is a server that provides various services so that a worker can perform a task on a project requested by a client.

Here, the project may be to create subtitle content for an original language (hereinafter, referred to as a source language) of a content image requested by the client, or to create a subtitle content translated from the source language of the content image into a target language requested by the client.

Specifically, the subtitle service server 100 may provide a subtitle content creating tool for creating a subtitle content for the content image requested by a client in response to a worker's request. In addition, the subtitle service server 100 may evaluate task performance of the worker based on the subtitle content created by the worker. Accordingly, the client may search for a worker suitable for the client based on evaluation information on task performance of workers provided by the subtitle service server 100, and a worker may search for a project suitable for the worker based on evaluation information on the worker himself or herself provided by the subtitle service server 100.

The user terminal device 200 may perform data communication with the subtitle service server 100 to transmit project information on a content image requested by the client to the subtitle service server 100, or may provide a window environment where the project requested by the client can be performed using various task tools provided by the subtitle service server 100.

The user terminal device 200 may be an Internet-enabled electronic device such as a desktop, a laptop, a tablet PC, and a smart phone.

Specifically, the user terminal device 200 of the client may access the subtitle service server 100 and transmit project information on the content image requested by the client. Here, the project information may include at least one of address information, title information, description information, and subtitling request information for the content image requested by the client. The description information may be detailed information on the content image, and the subtitling request information may include at least one of: a target language for translation, a requested completion date, task cost, a worker rating, and task difficulty information. In addition, the project information may include a content image file.

As such, when the project information requested by the client is received, the subtitle service server 100 may provide a project list for the worker based on the received project information, and the worker may select a project suitable for the worker based on the project list provided by the subtitle service server 100 and be assigned with the selected project. When the project requested by the worker is assigned, the user terminal device 200 of the worker displays a subtitle service window including the subtitle content creating tool provided from the subtitle service server 100.

Accordingly, the worker performs a task for the project selected by the worker through the subtitle service window displayed on the user terminal device 200 of the worker. That is, the worker may create subtitle content for the content image requested by the client through the subtitle service window displayed on the user terminal device 200 of the worker. When the creation of the subtitle content is completed, the worker's user terminal device 200 may transmit the subtitle content task-completed by the worker to the subtitle service server 100, and when the received subtitle content for which the task has been completed is received, the subtitle service server 100 may update a progress status of the project related to the subtitle content to a final completion status.

Specifically, when the subtitle content task-completed by the worker is received, the subtitle service server 100 may temporarily store the received subtitle content and update a progress status of a project related to subtitle content that has been reviewed among temporarily stored subtitle content to a final completion status. When the progress status of the project requested by the client is updated to the final completion status, the client performs electronic payment for the task cost through the subtitle service server 100, and when the electronic payment is completed, the subtitle service server 100 performs an operation of paying the task cost to the worker based on account information of the worker who has performed the task for the corresponding project.

So far, the operations of the subtitle service system 1000 according to the present disclosure has been briefly described. Hereinafter, operations to be performed by the subtitle service server 100 and the user terminal device 200 constituting the subtitle service system 1000 according to the present disclosure will be described in more detail.

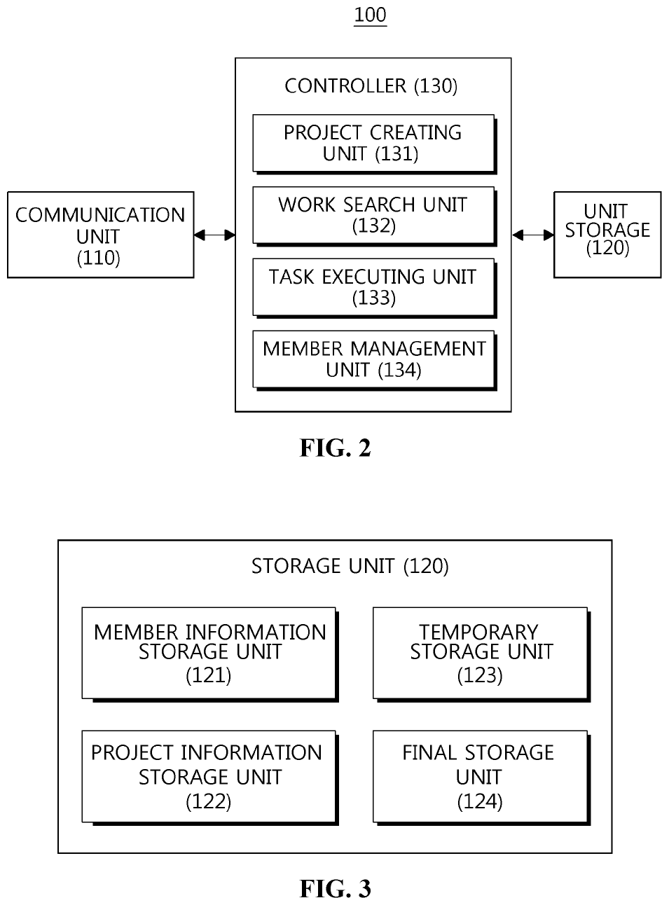

FIG. 2 is a block diagram of a subtitle service server according to an embodiment of the present disclosure.

As shown in FIG. 2, the subtitle service server 100 may include a communication unit 110, a storage unit 120, and a controller 130.

The communication unit 110 may perform data communication with a user terminal device 200. Here, the user terminal device 200 may include at least one of: a terminal device of a client who requests a project, a terminal device of a worker who performs a task for the project requested by the client, and a terminal device of a reviewer who reviews and evaluates a subtitle content task-completed by the worker.

The communication unit 110 may perform data communication with a user terminal device 200 of a client to receive project information on a content image requested by the client, and may perform data communication with a user terminal device 200 of a worker to provide a subtitle content creating tool for creating a subtitle content of a project selected by the worker.

The storage unit 120 may store project information on the content image requested by the client from the client's user terminal device 100. A detailed description of the storage unit 120 will be described in detail below.

The controller 130 may control the communication unit 110 and the storage unit 120 described above. The controller 130 may include a project creating unit 131, a worker search unit 132, and a task executing unit 133.

When a subtitle request command including project information on a content image requested by the client is received from the user terminal device 200 of the client, the project creating unit 131 determines as to validity of the corresponding content image based on address information included in the project information. As a result of the determination, if the validity of the content image is verified, the project creating unit 131 may store the received project information in the storage unit 120, and if the validity of the corresponding content image is not verified, the project creating unit 131 may transmit an error message to the user terminal device 200 of the client through the communication unit 110.

Meanwhile, if the received project information includes a video file for the content image requested by the client, the project creating unit 131 does not determine as to the validity of the received project information but may store the corresponding project information in the storage unit 120.

Meanwhile, the storage unit 120 may further store profile information of a pre-registered worker, and when a worker search command is received from the user terminal device 200 of the client, the worker search unit 131 may acquire profile information related to subtitling request information included in the received project information among profile information pre-registered in the storage unit 120 and may transmit the acquired profile information to the user terminal device 200 of the client. Thereafter, when translation request information is received from the user terminal device 200 of the client who has received the profile information, the worker search unit 131 may transmit a translation request message to the user terminal device 200 of the worker corresponding to the profile information.

Thereafter, the worker search unit 131 may determine whether a response message is received within a preset threshold time from the user terminal device 200 of the worker to whom the translation request message is transmitted, and may transmit a resulting message to the user terminal device 200 of the client who has requested the translation from the worker.

For example, when a response message related to acceptance of the task is received from the user terminal device 200 of the worker to whom the translation request message is transmitted, the worker search unit 131 may transmit a task acceptance message to the user terminal device 200 of the client who has requested the task from the worker. On the other hand, when a response message is not received within a preset threshold time from the user terminal device 200 of the worker to whom the translation request message is transmitted or when a response message related to non-acceptance of the task is received, the worker search unit 131 may transmit a failure message to the user terminal device 200 of the client who has requested the task from the worker.

When a project search command is received from the user terminal device 200 of the worker, the task executing unit 133 may transmit project list information including an item corresponding to at least one content image generated based on the project information stored in the storage unit 120 to the user terminal 200 of the worker.

According to an embodiment, when a project search command is received from the user terminal device 200 of the worker, the task executing unit 133 may generate project list information based on project information in a standby state among a plurality of pre-stored project information and transmit the generated project list information to the user terminal device 200 of the worker. Here, the project information in the standby state may be project information unselected by at least one pre-registered worker.

According to another embodiment, when a project search command is received from the user terminal device 200 of the worker, the task executing unit 133 may acquire the project information in the standby state related to the worker based on the subtitling request information included in the project information in the standby state, and may generate project list information based on the acquired project information to the user terminal device 200 of the worker.

For example, the project information in the standby state may include subtitling request information related to task cost. In this case, the task executing unit 133 may acquire project information including a task cost related to a work cost included in the worker's profile information, and generate project list information based on the acquired project information.

As another example, the project information in the standby state may include subtitling request information related to translation. In this case, the task executing unit 133 may acquire project information for requesting a translation language related to a specialized translation language included in the worker's profile information, and generate project list information based on the acquired project information.

According to another embodiment, when a project search command is received from the user terminal device 200 of the worker, the task executing unit 133 may, based on the subtitling request information included in the project information in the standby state, acquire the project information in the standby state related to the worker, and may generate project list information to the user terminal device 200 of the worker based on the acquired project information.

For example, the worker may be specialized in English translation in the medical field. In this case, the task executing unit 133 may, based on at least one of description information and subtitling request information included in the project information in the standby state, acquire project information for which English translation related to the medical field is requested, and may generate project list information based on the acquired project information and transmit the generated project list information to the user terminal device 200 of the worker.

Thereafter, when a command to select a first item among a plurality of items included in the project list is received from the user terminal device 200 of the worker, the task executing unit 133 may, based on project information of a first content image corresponding to the selected first item, transmit Web information on a subtitle content creating tool for creating a subtitle content of the first content image to the user terminal device 300 of the worker.

Accordingly, the user terminal device 200 of the worker may display the subtitle service window including the subtitle content creating tool based on the Web information received from the subtitle service server 100, and the worker may create a subtitle content requested by the client in relation to the first content image through the displayed subtitle service window.

According to a further aspect of the present disclosure, when a task-completed subtitle content is received from the user terminal device 200 of the worker, the task executing unit 131 may store the received subtitle content in the storage unit 120 and transmit, through the communication unit 110, a project completion message to the user terminal device 200 of the client who has requested the subtitle content.

According to a further aspect of the present disclosure, when a task-completed subtitle content is received from the user terminal device 200 of the worker, the task executing unit 131 may temporarily store the received subtitle content in a first area of the storage unit 120 and store, in the second area, a verified subtitle content among subtitle contents temporarily stored in the first area. Accordingly, when the subtitle content is stored in the second area, the task executing unit 131 may transmit a project completion message to the user terminal device 200 of the client who has requested the subtitle content.

Hereinafter, the storage unit 120 will be described in more detail.

FIG. 3 is a detailed block diagram of a storage unit according to an embodiment of the present disclosure.

As shown in FIG. 3, the storage unit 120 may include a member information storage unit 121, a project information storage unit 122, a temporary storage unit 123, and a final storage unit 124.

The member information storage unit 121 may store profile information for all pre-registered members. Here, a pre-registered member may include a client who has requested a project, a worker who performs a task for the project requested by the client, and a reviewer who performs verification (review) on a subtitle content task-completed by the worker.

Such profile information of member may include at least one of ID information, contact information, email information, payment information, gender, and age information of the client. Meanwhile, when the member is a worker or a reviewer, the reviewer's profile information may further include at least one of task rating information and history information in addition to the above-described information.

The project information storage unit 122 may store project information for a content image requested by a pre-registered client. Here, the project information may include at least one of address information, title information, description information, and subtitling request information for the content image. In addition, the description information may be detailed information on the content image, and the subtitling request information may include at least one of: a target language for translation, a requested completion date, task cost, worker rating, and task difficulty information. In addition, the project information may include a content image file.

Meanwhile, the project information storage unit 122 may classify and store information on a project unassigned to a worker, information on a project assigned to the worker, and information on a project task-completed by the worker among the project information requested by the client.

The temporary storage unit 123 may temporarily store a subtitle content task-completed by a worker, and the final storage unit 124 may store a subtitle content verified by the reviewer among subtitle contents stored in the temporary storage unit 123.

Specifically, a user terminal device 200 of the reviewer which is connected to the subtitle service server 100 may provide a list of subtitle contents stored in the temporary storage unit 123 in response to a request from the reviewer. Thereafter, when a command to select a first subtitle content from among the subtitle contents included in the list is received, the task executing unit 133 may transmit the Web information of the review tool for the first subtitle content to the user terminal device 200 of the reviewer.

Therefore, the user terminal device 200 of the reviewer may display the window of the review tool for the first subtitle content, and the reviewer may detect typos, mistranslations, etc. from subtitles included in the first subtitle content through the window of the review tool. When the verification of the first subtitle content is completed, the user terminal device 200 of the reviewer may transmit an review completion message to the subtitle service server 100.

When the review completion message for the first subtitle content is received from the user terminal device 200 of the reviewer, the task executing unit 133 may delete the first subtitle content stored in the temporary storage unit 123 and store the first subtitle content reviewed by the reviewer in the final storage unit 124.

According to a further aspect of the present disclosure, the controller 130 may further include a member management unit 134.

When a registration request command is received from the user terminal device 200 of an unregistered worker, the member management unit 134 may generate task rating information of the unregistered worker by evaluating test performance of the unregistered worker. Thereafter, the member management unit 134 may generate profile information, which includes the task rating information and at least one of personal information, history information, cost information, and evaluation information provided by the unregistered worker, and may store the generated profile information in the storage unit 120. Accordingly, the storage unit 120 may store the profile information on the unregistered worker in the member information storage unit 121.

Meanwhile, the member management unit 134 may update task rating information for a pre-registered worker based on at least one of: task execution period information for a subtitle content task-completed by the pre-registered worker, error correction information, and user evaluation information by a user who has used the subtitle content.

For example, when the subtitle content for the content image requested by the client is completed, the member management unit 134 may evaluate task performance of the worker by referring to the worker's task execution period for the subtitle content as well as the client's requested completion date based on project information of the client who has requested the corresponding subtitle content.

In another example, the member management unit 134 may update the task rating information of the worker based on the above-described task performance evaluation information and review evaluation information of the reviewer who has verified the subtitle content task-completed by the worker.

In another example, the member management unit 134 may update the task rating information of the worker, who has performed the task on the subtitle content, based on the above-described task performance evaluation information, the review evaluation information, and the evaluation information by a user who has used the corresponding subtitle content.

So far, the configuration of the subtitle service server 100 according to the present disclosure and the operation of each configuration have been described in detail. Hereinafter, the user terminal device 200 according to the present disclosure will be described in detail.

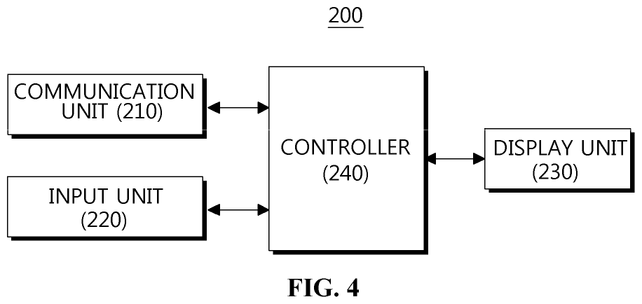

FIG. 4 is a block diagram of a user terminal device according to an embodiment of the present disclosure.

The user terminal device 200 may be an electronic device such as a desktop, a laptop, a smart phone, or a tablet. As shown in FIG. 4, the user terminal device 200 may include a communication unit 210, an input unit 220, a display unit 230, and a controller 240.

The communication unit 210 may perform data communication with the subtitle service server 100 to transmit and receive project information on a content image requested by a client, a subtitle content task-completed by a worker, information on the subtitle content reviewed by a reviewer, and the like.

According to an embodiment, the communication unit 210 may include a connector that includes at least one of the following: a wireless communication module such as a short-range communication module and a wireless LAN module; and a wired communication module such as a High-Definition Multimedia Interface (HDMI), a Universal Serial Bus (USB), and an Institute of Electrical and Electronics Engineers (IEEE) 1394.

The short-range communication module is configured to perform wireless short-range communication with nearby devices in a short range from the user terminal device 200, artificial intelligence servers, and the like. The short-distance communication module may include at least one of a Bluetooth module, an infrared data association (IrDA) module, a near field communication (NFC) module, a WIFI module, and a Zigbee module.

In addition, the wireless communication module is a module that is connected to an external network according to a wireless communication protocol such as IEEE to perform data communication with the subtitle service server 100 and a relay device (not shown). In addition, the wireless communication module may further include a mobile communication module that performs communication by accessing a mobile communication network according to various mobile communication standards such as 3G to 5G (3rd to 5th generation), 3GPP (3rd Generation Partnership Project), and LTE (Long Term Evoloution).

As such, the communication unit 210 may be implemented by the various short-distance communication methods described above, and may employ other communication technologies not mentioned herein, if necessary.

Meanwhile, the connector is configured to provide an interface with various source devices, such as USB 2.0, USB 3.0, HDMI, IEEE 1394, and the like. Such a connector may receive content data transmitted from a content providing server (not shown) through a wired cable connected to the connector according to a control command of the controller 240 to be described later, or may transmit pre-stored content data to an external recording medium. Also, the connector may receive power from a power source through a wired cable physically connected to the connector.

The input unit 220 is an input means for receiving various user commands and transmitting the user commands to the controller 240 to be described later. In particular, the input unit 220 may receive a user command for accessing the subtitle service server 100, a project request command for requesting a task content for a content image of a client, a task assignment command for assigning a worker with a task for the requested project, and the like. The input unit 220 may include a microphone (not shown) for receiving a user's voice command, an operation unit (not shown) implemented as a keypad equipped with various function keys, number keys, special keys, character keys, etc., a touch input unit (not shown) for receiving a user's touch command through the display unit 230 to be described later, and the like.

The display 230 may display various content images, an execution icon corresponding to each pre-registered application, an execution screen of an application corresponding to a selected icon, and the like. In particular, when the user terminal device 200 is connected to the subtitle service server 100, the display 130 may display a subtitle service window provided by the subtitle service server 100.

The display 230 may be implemented as a liquid crystal display (LCD), an organic light emitting diode (OLED), or the like. In particular, the display 230 may be implemented in the form of a touch screen formed in a mutually layered structure together with a touch input unit (not shown) that receives a user's touch command as described above.

The controller 240 may control the overall operation of each element forming the user terminal device 200. In particular, the controller 240 may control the display 230 to display a subtitle service window according to a user command input through the input unit 220. Accordingly, the display 230 may display the subtitle service window provided to the subtitle service server 100 according to a control command of the controller 240.

In a state in which the subtitle service window is displayed, when a command to select a project creating icon included in an area of the subtitle service window is received, the controller 240 may control the display 230 to display a first client window for inputting project information on a content image.

Here, the first client window may include at least one of: a first UI for setting at least one of a language task for a source language included in the content image and a translation task for translating into a target language requested by the client, and a second UI for inputting address information on the content image.

According to a further aspect of the present disclosure, the subtitle service window may further include a My Project icon for searching for a progress status of the project requested by the client. Accordingly, when a command to select the My Project icon is received, the controller 240 may control the display 230 to display a second client window for the client's project search.

Here, the second client window may include at least one of: a first UI for setting a progress status of the project requested by the client, a second UI for searching for a project task execution period, a third UI for selecting a source language of the content image, a fourth UI for selecting a target language, and a fifth UI for searching for a specific project.

According to a further aspect of the present disclosure, the subtitle service window may further include at least one of: a project search icon for searching for a project to work on, and a worker project search icon for searching for a project assigned to a worker. Accordingly, when a command to select the project search icon is received, the controller 240 may control the display 230 to display a first worker window to search for a project available to work on.

Here, the first worker window may include at least one of: a first UI for selecting a source language included in the content image, a second UI for selecting a target language requested by the client, a third UI for selecting a task execution period, a fourth UI for selecting a category for the content image, and a fifth UI for setting task difficulty.

Meanwhile, when a command to select the worker project search icon is received, the controller 240 may control the display to display a second worker window for searching a project assigned to a worker.

Here, the second worker window may include at least one of: a first UI for selecting a task type, a second UI for retrieving a task progress status, a third UI for selecting a remaining task period of the task, a fourth UI for selecting a source language included in the content image, and a fifth UI for selecting a target language.

Meanwhile, when one of the projects found through the second worker window is selected, the controller 240 may control the display 230 to display a subtitle content creating tool window for performing a task for the selected project.

According to such a control command, the display 230 may display a content image related to the selected project in a first area of the subtitle content tool window, display a subtitle content creating tool UI for generating a subtitle content for each section of the content image in the second area, and display a subtitle content editing tool UI for editing a playback period of the subtitle content for each section generated through the subtitle content creating tool UI in the third area.

According to a further aspect of the present disclosure, the subtitle service window may further include a performance evaluation icon for searching for a worker's task performance indicator. Therefore, when a command to select the performance evaluation icon is received, the controller 240 may control the controller to display a worker performance evaluation window that includes at least one of: a first UI for performance evaluation test of an unregistered worker, and a second UI for providing test performance evaluation information on a pre-registered worker.

Hereinafter, the operation of generating a subtitle content for a content image requested by a client in the aforementioned user terminal device 100 will be described in more detail.

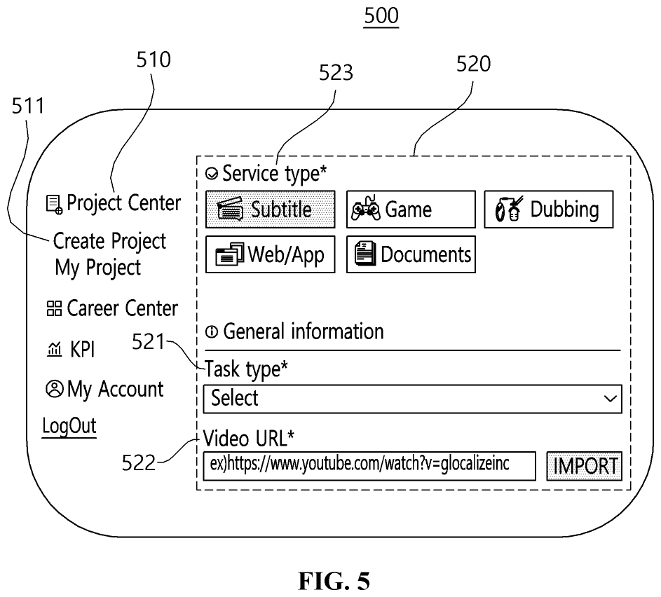

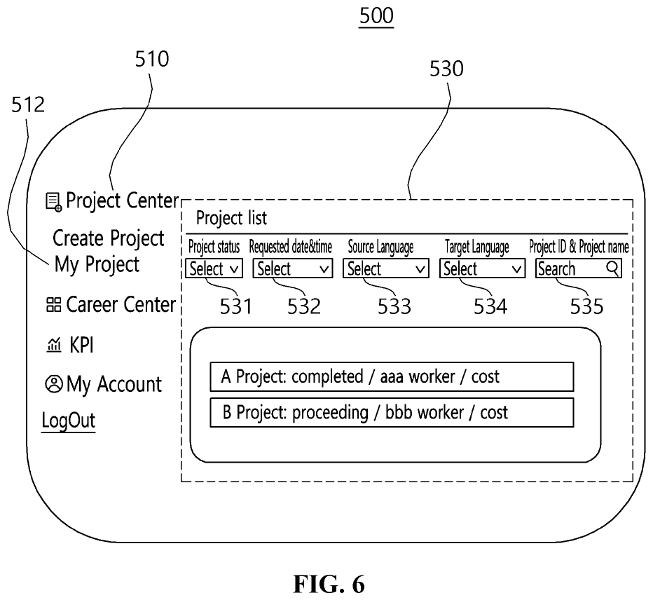

FIGS. 5 and 6 are diagrams illustrating an example of displaying a subtitle service window for a client in a user terminal device according to an embodiment of the present disclosure.

As shown in FIG. 5, the user terminal device 200 connected to the subtitle service server 100 may display the subtitle service window 500 provided by the subtitle service server 100 by accessing the subtitle service server 100. A project creating UI (Project Center) 510 for a client may be displayed in one area of the subtitle service window 500.

Thereafter, when a command to select a project creating icon 511 among icons included in the project creating UI 510 is received from the client, the client's user terminal device 200 may display the first client window 520 for inputting project information on the content image to be requested by the client. As described above, the first client window 520 may include at least one of: a first UI 521 for setting at least one of a language task for a source language included in the content image and a translation task for translating into a target language requested by the client, and a second UI 522 for inputting address information on the content image.

Accordingly, the client may set a type of subtitle to be inserted into the content image through the first UI 521 of the first client window 520, and input the address information on the content image through the second UI 522.

Meanwhile, the first client window 520 may further include a third UI 523 for setting a category (movie subtitle, game, document, etc.) for the content image requested by the client. Accordingly, the client may set the category for the content image to be requested, through the third UI 523 of the first client window 520.

When the setting by the client is completed, the user terminal device 200 of the client may transmit the project information set by the client to the subtitle service server 100, and the subtitle service server 100 may store the project information, received from the user terminal device 200 of the client, in the project information storage unit 122 of the storage unit 120.

Meanwhile, as shown in FIG. 6, when a command to select a My Project icon 512 from among the icons included in the project creating UI 510 is received from the client, the user terminal device 200 of the client may display the second client window 530 for a project search by the client. As described above, the second client window 530 may include at least one of: a first UI 531 for setting a progress status of a project requested by the client, a second UI 532 for searching for a project task execution period, a third UI 533 for selecting a source language of a content image, a fourth UI 534 for selecting a target language, and a fifth UI 535 for searching for a specific project. In addition, the second client window 530 may further include a sixth UI 536 for displaying a search result corresponding to a user command of the client input to at least one of the first to fifth UIs 531 to 535.

For example, through the first UI 531, the client may request a search for a project on which a task for subtitle content has been completed from among projects requested by the client. When such a user command of the client is received, the client's user terminal device 200 may receive, from the subtitle service server 100, a search result list for a project on which a task for subtitle content has been completed among the client's pre-registered projects and may display the search result list on the sixth UI 536.

When such a user command of the client is received, the user terminal device 200 of the client may receive, from the subtitle service server 100, a search result list for a project on which a task for subtitle content has been completed among the client's pre-registered projects, and may display the search result list on the sixth UI 536.

Meanwhile, through the first UI 531, the client may request a search for a project on which a task for subtitle content is being performed among the projects requested by the client. When such a user command of the client is received, the user terminal device 200 of the client may receive, from the subtitle service server 100, information on a project on which a task for subtitle content is being performed among the client's pre-registered projects, and may, based on the received information, a search result list for at least one project on which the task is completed on the sixth UI 536.

As shown, when the task of subtitle content for project B is being performed, the user terminal device 200 of the client may display a search result list for the project B on the sixth UI 536 based on the information received from the subtitle service server 100.

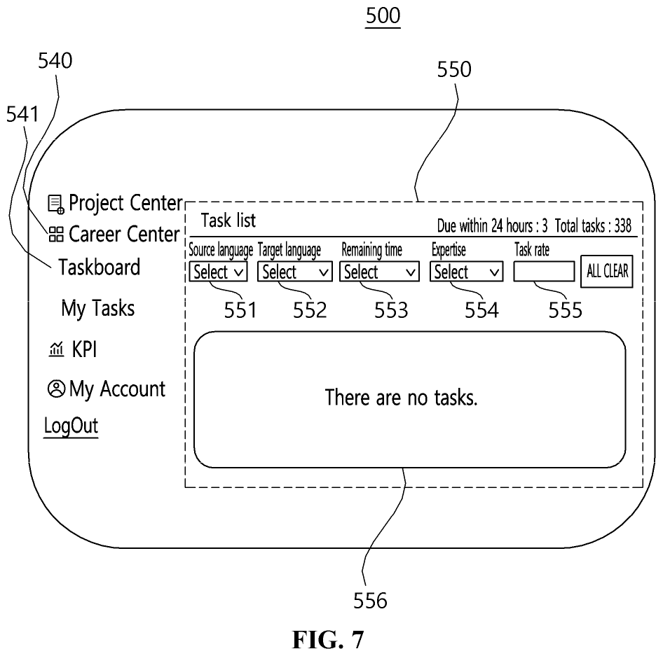

FIGS. 7 to 9 are diagrams illustrating an example of displaying a subtitle service window for a worker in a user terminal device according to an embodiment of the present disclosure.

As shown in FIG. 7, a project task UI (Career Center) 540 for workers may be displayed in one area of the subtitle service window 500. Thereafter, when a command to select a project search icon (Taskboard) 541 for searching for a project to work on among icons included in the project task UI 540 is received from a worker, the user terminal device 200 of the worker may display a first worker window 550 for searching for a project available to work on.

As described above, the first worker window 550 may include at least one of: a first UI 551 for selecting a source language included in a content image, a second UI 552 for selecting a target language requested by the client, a third UI 553 for selecting a task execution period, a fourth UI 554 for selecting a category for the content image, and a fifth UI 555 for setting task difficulty. In addition, the first worker window 550 may further include a sixth UI 556 for displaying a search result corresponding to a user command of the worker into to at least one of the first to fifth UIs 551 to 555.

For example, the worker my select a first language (Korean) as the source language of the content image through the first UI 551, select a second language (English) as the requested target language through the second UI 552, and select one month as a task execution period through the third UI 553.

When the worker's user command is received, the worker's user terminal device 200 may receive, from the subtitle service server 100, a search result list for at least one project corresponding to the work's input user command among a plurality of projects pre-registered in the subtitle service server 100, and may display the search result list on the sixth UI 556.

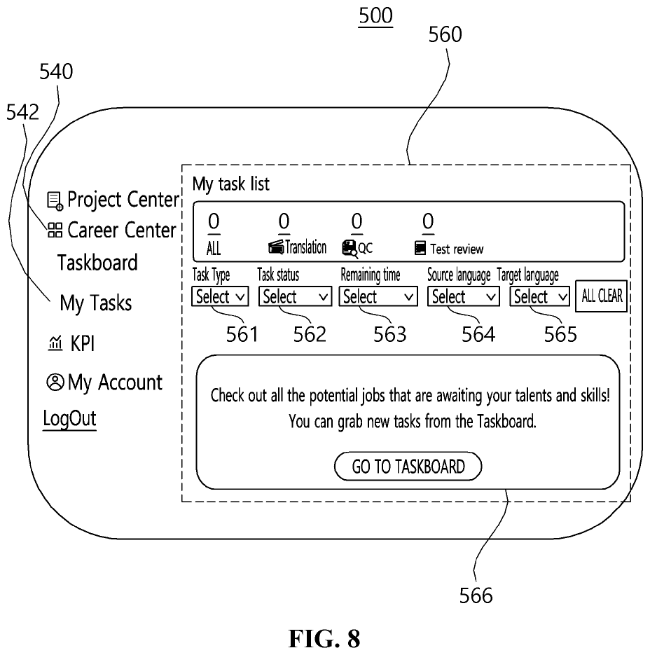

Meanwhile, as shown in FIG. 8, when a command to select a project search icon 542 is received from the worker, the worker's user terminal device 200 may control the display so as to display the second worker window 560 for searching for a project assigned to the worker.

As described above, the second worker window 560 may include at least one of: a first UI 561 for selecting a task type, a second UI 562 for searching for a task progress status, a third UI 563 for selecting a remaining task execution period, a fourth UI 564 for selecting a source language included in the content image, and a fifth UI 565 for selecting a target language. In addition, the second worker window 560 may further include a sixth UI 566 for displaying a search result corresponding to a user command of the worker input to at least one of the first to fifth UIs 561 to 565.

For example, the worker may select a translation-related task type through the first UI 561, select a status of the task being performed through the second UI 562, and select a second language (English) as a target language through the fifth UI 562. When the worker's user command is received, the worker's user terminal device 200 may receive, from the subtitle service server 100, a search result list for a project on which a translation-related task being performed in a second language among the worker's projects pre-registered in the subtitle service server 100, and may display the search result list on the sixth UI 566.

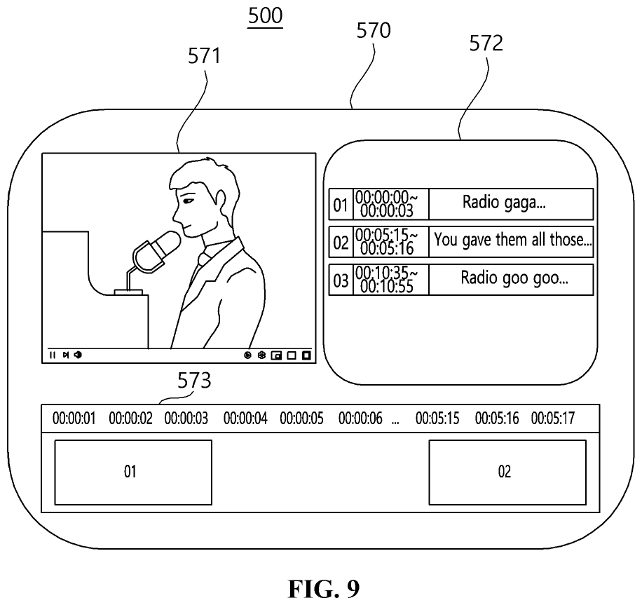

In a state in which the search result list corresponding to the request of the worker is displayed on the sixth UI 566, when one of the projects included in the search result list is selected, the worker's user terminal device 200 may display the subtitle content creating tool window 570 for performing a task on the selected project, as shown in FIG. 9.

Specifically, when a command to select a first project from among the projects included in the search result list is received from the worker, the user terminal device 200 of the worker may display a content image related to the selected first project in a first selected first area 571 of a subtitle content creating tool window 570, display a subtitle content creating tool UI for generating a subtitle content for each section of the corresponding content image in the second area 572, and display a subtitle content editing tool UI for editing a playback period of the subtitle content for each section generated through the subtitle content creating tool UI in the third area 573.

Accordingly, through the second area 572, the worker may translate a source language of a content image displayed in the first area 571 of each section into a target language requested by the client.

For example, the source language may be included in a first section (00:00:00 to 00:00:03) of the content image. In this case, the worker may translate the source language of the first section into the target language requested by the client through the second area 572. Through this example, first to third subtitle contents 01 to 03 for respective sections translated by the worker in relation to the content image may be displayed in the second area 572.

Meanwhile, when the first to third subtitle contents (01 to 03) for each section are generated in relation to the corresponding content image, the user terminal device 200 of the worker may, based on time information corresponding to each of the first to third subtitle contents, display playback periods of the first to third subtitle contents 01 to 03 for the respective playback time of the corresponding content images in the form of a bar through the third area 573. Accordingly, the worker may edit the playback period of each of the first to third subtitle contents by adjusting a length of a bar corresponding to each of the first to third subtitle contents displayed in the third area 573.

So far, in the user terminal device 200 according to the present disclosure, an operation of registering project information on the content image requested by the client through the subtitle service window provided to the subtitle service server 100 in the subtitle service server 100 and performing a worker's task on a project pre-registered in the subtitle service server 100 has been describe in detail. Hereinafter, a method for controlling the subtitle service server 100 that provides a subtitle service according to the present disclosure will be described in detail.

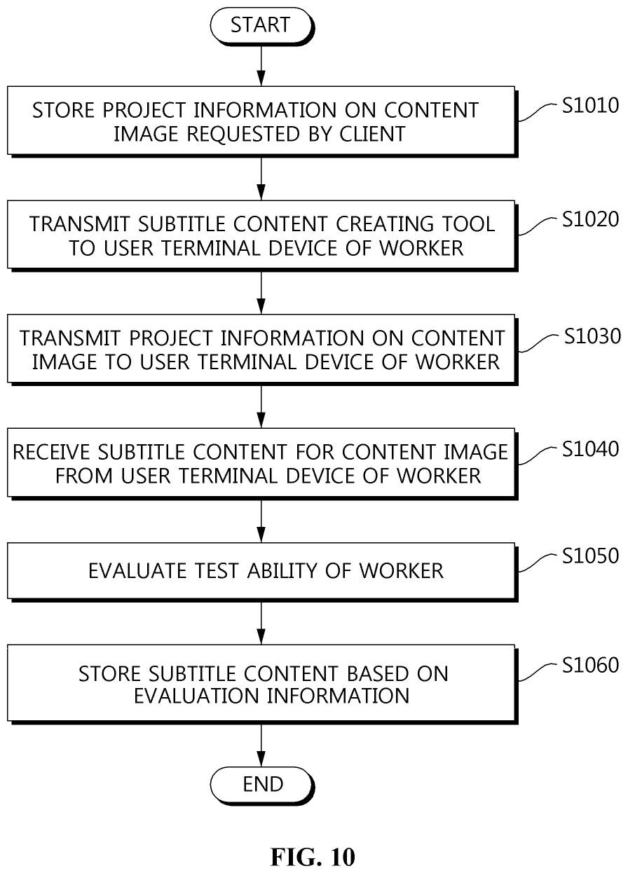

FIG. 10 is a flowchart of a method for controlling a subtitle service server according to an embodiment of the present disclosure.

As shown in FIG. 10, the subtitle service server 100 may register project information on a content image requested by a client in operation 1010. Here, the project information may include at least one of address information, title information, description information, and subtitling request information for the content image.

Specifically, when a subtitle request command including project information on a content image is received from the user terminal device 200 of the client, the subtitle service server 100 may determine as to validity of the content image based on address information included in the project information. Thereafter, when the validity of the content image is verified, the subtitle service server 100 may store the project information in the storage unit, and when the validity of the content image is not verified, the subtitle service server 100 may transmit an error message to the user terminal device 200 of the client.

Meanwhile, when a worker search command is received from the user terminal device 200 of the client, the subtitle service server 100 may acquire profile information related to subtitling request information included in the project information among pre-registered workers' profile information and transmit the acquired profile information to the user terminal device 200 of the client. Thereafter, when translation request information is received from the user terminal device 200 of the client who has received the profile information, the subtitle service server 100 may transmit a translation request message to the user terminal device 200 of the worker corresponding to the profile information.

Thereafter, in response to the request from the worker, the subtitle service server 100 may transmits a subtitle content creating tool for creating a subtitle content for the content image requested by the client to the user terminal device of the worker in operation S1020. Thereafter, the subtitle service server 100 may transmit the project information on the content image to the user terminal device 200 of the worker in operation S1030.

Specifically, when a project search command is received from the user terminal device 200 of the worker, the subtitle service server 100 may transmit, to the user terminal device 200 of the worker, project list information including an item corresponding to at least one content image that is generated based on pre-stored project information. Thereafter, when a command to select a first item is received from the user terminal device of the worker, the subtitle service server 100 may, transmit Web information for a subtitle content creating tool for creating a subtitle content of the first content image to the user terminal device 200 of the worker based on project information of the first content item corresponding to the selected first item. Accordingly, the worker may create the subtitle content for the first content image through the subtitle service window including the subtitle content creating tool displayed on the user terminal device 200 of the worker. When a task for the subtitle content for the first content image is completed, the user terminal device 200 of the worker may transmit a task-completed subtitle content to the subtitle service server 100.

When the subtitle content for the task-completed content image is received from the user terminal device 200 of the worker, the subtitle service server 100 may evaluate task performance of the worker based on the received subtitle content in operations S1040 and S1050.

Thereafter, the subtitle service server 100 may store the subtitle content received from the user terminal device 200 of the worker based on the evaluation information which is evaluated based on the received subtitle content in operation S1060.

Specifically, when the subtitle service server 100 receives the subtitle content for the task-completed content image from the worker's user terminal device 200, the subtitle service server 100 may store the received subtitle content in the temporary storage unit. Meanwhile, when an review command is received from a user terminal device 200 of a reviewer, the subtitle service server 100 may provide a list of subtitle contents stored in the temporary storage unit to the user terminal device 200 of the reviewer. Accordingly, the user terminal device 200 of the reviewer may display the list received from the subtitle service server 100.

Meanwhile, when a command to select a first subtitle content from among subtitle contents included in the list is received from the user terminal device 200 of the reviewer, the subtitle service server 100 may transmit Web information of the review tool for the first subtitle content to the user terminal device 200 of the reviewer. Accordingly, the reviewer may perform review on the first subtitle content through the user terminal device 200 of the reviewer, and the user terminal device 200 of the reviewer may transmit a review completion message regarding the first subtitle content reviewed by the reviewer to the subtitle service server 100.

When the review completion message regarding the first subtitle content is received from the user terminal device of the reviewer, the subtitle service server 100 may delete the first subtitle content stored in the temporary storage unit may store the first subtitle content reviewed by the reviewer in the final storage unit.

In this case, the subtitle service server 100 may evaluate task performance of the worker who has performed the task on the subtitle content, in consideration of a task execution period for the task-completed subtitle content, information on corrections made by the reviewer, and the like. Thereafter, the subtitle service server 100 may update a task rating information of the worker based on a result of the evaluation of the corresponding worker. In addition, the subtitle service server 100 may update task rating information of the worker, who has performed a task on the subtitle content, based on evaluation information by a user who has used the subtitle content.

Meanwhile, when the reviewed subtitle content is stored in the final storage unit, the subtitle service server 100 may transmit a project completion message to the user terminal device 200 of the client who has requested the subtitle content. Accordingly, the client may confirm that the task for the project requested by the client is completed, through a project completion message displayed on the user terminal device 200 of the client.

Meanwhile, when a registration request command is received from a user terminal device 200 of an unregistered worker, the subtitle service server 100 may generate task rating information on the unregistered worker by evaluating text performance of the unregistered worker. Thereafter, the subtitle service server 100 may generate and store profile information, which includes task rating information and at least one of personal information, history information, cost information, and evaluation information provided from the unregistered worker.

Therefore, the client may request a specific worker to perform a task on the project by referring to profile information on pre-registered workers, or may allow the project to be opened to a worker who meets conditions set by the client.

Meanwhile, the method for controlling the user terminal device and the server according to various embodiments in various embodiments may be coded in software and stored in non-transitory readable media. Such non-transitory readable media can be installed and used in a variety of devices.

A non-transitory readable medium is not a medium for storing data for a short time such as a register, cache or memory, but refers to a medium that semi-permanently stores data and can be read by a device. Specifically, the non-transitory readable medium may include a CD, DVD, hard disk, Blu-ray disc, USB, memory card, or ROM.

Hereinabove, exemplary embodiments of the present invention have been described with reference to the accompanying drawings. Specific terms or words used herein should be construed in accordance with the spirit of the present invention. It should be understood that many variations and modifications of the basic inventive concept described herein will still fall within the spirit and scope of the present invention as defined in the appended claims and their equivalents.

1. A subtitle service system comprising:
a subtitle service server configured to, in response to a request from a worker, provide a subtitle content creating tool for creating a subtitle content for a content image requested by a client and evaluate task performance of the worker based on the subtitle content created by the worker; and
a user terminal device configured to access the subtitle service server to transmit project information on the content image requested by the client, and, in response to a request from the worker, display a subtitle service window including the subtitle content creating tool provided by the subtitle service server,
wherein the project information comprises at least one of: address information, title information, description information, and subtitling request information for the content image.

2. The subtitle service server of claim 1,
wherein the subtitle service providing server comprises:
a communication unit configured to perform data communication with at least one of: a user terminal device of the client, and a user terminal device of the worker;
a storage unit configured to store the project information on the content image received from the user terminal device of the client; and
a controller configured to control the communication unit and the storage unit;
wherein the controller comprises a project creating unit configured to:
when a subtitle request command including the project information on the content image is received from the user terminal device of the client, determine as to validity of the content image based on the address information included in the project information, and when the validity of the content image is verified, store the project information in the storage unit; and
when the validity of the content image is not verified, transmit an error message to the user terminal device of the client through the communication unit.

3. The subtitle service system of claim 2,
wherein the storage unit is further configured to store at least one of profile information of pre-registered workers,
wherein the controller further comprises a worker search unit configured to:
when a worker search command is received from the user terminal device of the client, acquire profile information related to subtitling request information included in project information among pre-registered profile information and transmit the acquired profile information to the user terminal device of the client; and
when translation request information is received from the user terminal device of the client that has received the profile information, transmit a translation request message to a user terminal device of a worker corresponding to the profile information.

4. The subtitle service system of claim 2,
wherein the controller further comprises a task executing unit configured to:
when a project search command is received from the user terminal device of
the worker, transmit, to the user terminal device of the worker, project list information including an item corresponding to at least one content image created based on the project information stored in the storage unit; and
when a command to select a first item is received from the user terminal device of the worker, transmit, based on project information of a first content image corresponding to the selected first item, Web information on a subtitle content creating tool for creating a subtitle content of the first content image to the user terminal device of the worker.

5. The subtitle service server of claim 4,
wherein the task executing unit is configured to:
when a task-completed subtitle content is received from the user terminal device of the worker, store the received subtitle content in the storage unit; and
transmit a project completion message to the user terminal device of the client who has requested the subtitle content.

6. The subtitle service server of claim 5,
wherein the storage unit comprises:
a temporary storage unit configured to store the task-completed subtitle content; and
a final storage unit configured to store a verified subtitle content among subtitle contents stored in the temporary storage unit,
wherein the task executing unit is further configured to:
when a review command is received from a user terminal device of a reviewer, provide a list of subtitle contents stored in the temporary storage unit, and when a command to select a first subtitle content from among the subtitle contents included in the list is received, transmit Web information on a review tool for the first subtitle content to the user terminal device of the reviewer; and
when a review completion message for the first subtitle content is received from the user terminal device of the reviewer, delete the first subtitle content stored in the temporary storage unit and store the first subtitle content reviewed by the reviewer in the final storage unit.

7. The subtitle service system of claim 3,
wherein the controller further comprises a member management unit configured to, when a registration request command is received from a user terminal device of an unregistered worker, generate task rating information on the unregistered worker by evaluating text performance of the unregistered worker, generate profile information, which comprises the task rating information and at least one of personal information, history information, cost information, and evaluation information provided from the unregistered worker, and store the generated profile information in the storage unit.

8. The subtitle service system of claim 7,
wherein the member management unit is further configured to update task rating information on a pre-registered worker using at least one of: task execution period information for a subtitle content task-completed by the pre-registered worker, error correction information, and evaluation information by a user who has used the subtitle content.

9. The subtitle service system of claim 1,
wherein the user terminal device comprises:
a communication unit configured to perform data communication with the subtitle service server;
an input unit configured to receive a user command;
a display; and
a controller configured to: display the subtitle service window in accordance with a user command input through the input unit, and when a command to select a project creating icon included in an area of the subtitle service window is received, control the display to display a first client window for inputting project information on the content image,
wherein the first client window comprises at least one of: a first UI for setting at least one of a language task and a translation task of the content image, and a second UI for inputting address information on the content image.

10. The subtitle service system of claim 9,
wherein the subtitle service window further comprises a My Project icon for searching for a progress status of a project requested by the client,
wherein the controller is further configured to, when a command to select the My Project icon is received, control the display to display a second client window for the project search by the client,
wherein the second client window comprises at least one of: a first UI for setting a progress status of the project requested by the client, a second UI for searching for a project task execution period, a third UI for selecting a source language of the content image, a fourth UI for selecting a target language, and a fifth UI for searching for a specific project.

11. The subtitle service system of claim 9,
wherein the subtitle service window further comprises at least one of: a project search icon for searching for a project to work on, and a worker project search icon for searching for a project assigned to the worker,
wherein the controller is further configured to, when a command to select the project search icon is received, control the display to display a first worker window for searching for a project available to work on, and
wherein the first worker window comprises at least one of: a first UI for selecting a source language included in the content image, a second UI for selecting a target language requested by the client, a third UI for selecting a task execution period, a fourth UI for selecting a category for the content image, and a fifth UI for setting task difficulty.

12. The subtitle service system of claim 11,
wherein the controller is further configured to, when a command to select the worker project search icon is received, control the display to display a second worker window for searching for a project assigned to the worker, and
wherein the second worker window comprises at least one of: a first UI for selecting a task type, a second UI for searching for a task progress status, a third UI for selecting a remaining task execution period, a fourth UI for selecting a source language included in the content image, and a fifth UI for selecting a target language.

13. The subtitle service system of claim 12,
wherein the controller is further configured to, when one of projects found through the second worker window is selected, control the display to display a subtitle content creating tool window for performing a task on the selected project,
wherein the display is further configured to display a content image related to the selected project in a first area of the subtitle content tool window, display a subtitle content creating tool UI for creating a subtitle content for each section of the content image in a second area of the subtitle content tool window, and display a subtitle content editing tool UI for editing a playback period of a subtitle content for each section created through the subtitle content creating tool UI in a third area of the subtitle content tool window.

14. The subtitle service system of claim 9,
wherein the subtitle service window further comprises a performance evaluation icon for searching for a task performance indicator of a worker, and
wherein the controller is further configured to, when a command to select the performance evaluation icon is received, control the display so as to display a worker performance evaluation window including at least one of: a first UI for a performance evaluation test of an unregistered worker, and a second UI for providing test performance evaluation information on a pre-registered worker.

15. A method for controlling a subtitle service server that provides a subtitle service, the method comprising:
registering project information on a content image requested by a client;
transmitting, in response to a request from a worker, a subtitle content creating tool for creating a subtitle content for the content image requested by the client to a user terminal device of the worker;
transmitting the project information on the content image to the user terminal device of the worker;
receiving, from the user terminal device of the worker, a task-completed subtitle content for the content image through a subtitle service window including the subtitle content creating tool;
evaluating task performance of the worker based on the received subtitle content; and
storing the received subtitle content based on the evaluation information,
wherein the project information comprises at least one of: address information, title information, description information, and subtitling request information for the content image.

16. The method of claim 15,
wherein the registering comprises:
receiving a subtitle request command comprising project information for a content image from a user terminal device of the client;
determining as to validity of the content image based on the address information included in the project information; and
when the validity of the content image is verified, storing the project information in the storage unit, and when the validity of the content image is not verified, transmitting an error message to the user terminal device of the client.

17. The method of claim 16, further comprising:
when a worker search command is received from the user terminal device of the client, acquiring profile information related to the subtitling request information included in the project information among pre-registered workers' profile information and transmitting the acquired information to the user terminal device of the client; and
when translation request information is received from the user terminal device of the client who has received the profile information, transmitting a translation request message to a user terminal device of an worker corresponding to the profile information.

18. The method of claim 16, further comprising:
when a project search command is received from the user terminal device of the worker, transmitting project list information comprising an item corresponding to at least one content image generated based on pre-stored project information to the user terminal device of the worker; and
when a command to select a first item is received from the user terminal device of the worker, transmitting, based on project information on a first content corresponding to the selected first item, Web information on a subtitle content creating tool for creating a subtitle content of the first content to the user terminal device of the worker.

19. The method of claim 18, further comprising:
transmitting a project completion message to the user terminal device of the client who has requested the subtitle content,
wherein the storing comprises:
when a task-completed subtitle content is received from the user terminal device of the worker, storing the received subtitle content in a temporary storage unit;
when an review command is received from a user terminal device of a reviewer, providing a list of subtitle contents stored in the temporary storage unit;
when a command to select a first subtitle content from among the subtitle contents included in the list is received, transmitting Web information on an review tool for the first subtitle content to the user terminal device of the reviewer; and
when a review completion message regarding the first subtitle content is received from the user terminal device of the reviewer, deleting the first subtitle content stored in the temporary storage unit and storing the first subtitle content reviewed by the reviewer in the final storage unit.

20. The method of claim 17, further comprising:
when a registration request command is received from a user terminal device of an unregistered worker, generating task rating information on the unregistered worker by evaluating text performance of the unregistered worker;
generating and storing profile information, which comprises the task rating information and at least one of personal information, history information, cost information, and evaluation information provided from the unregistered worker; and
updating task rating information on a pre-registered worker using at least one of the following: task execution period information for a subtitle content completed by a pre-registered worker, error correction information, and evaluation information by a user who has used the subtitle content.
